(19) United States
(12) Patent Application Publication
(10) Pub. No.: US 2011/0307265 A1
(43) Pub. Date: Dec. 15, 2011

(54) REMOTE PHARMACY ORDERING TERMINAL

(76) Inventor: Amr Bannis, Markham (CA)

(21) Appl. No.: 12/984,867

(22) Filed: Jan. 5, 2011

(30) Foreign Application Priority Data
Jun. 11, 2010 (CA) 2,707,411

(51) Int. Cl. G06Q 50/00; G06Q 10/00

(52) U.S. Cl. 705/2

(57) ABSTRACT

This invention allows a mail order pharmacy and a network of community pharmacies to provide a service whereby customers place orders for prescription medications & over-the-counter (OTC) products online or from conveniently located terminals. Prescribing physician can directly send prescription(s) by fax, phone or electronically to processing pharmacy; or consumer(s) deliver original prescription(s) for these orders in the terminals. The original prescription is collected and verified before the order is shipped or picked-up, particularly for narcotics and other controlled medications. A back-end processing system verifies all entered data against pharmacy databases and automatically matches prescription forms with the customer's order using a unique barcode. This invention considerably reduces the wait time needed to process a prescription order and receive the product, while providing convenience, privacy, and security measures in compliance with regulatory requirements.

### RELATED APPLICATION

This application claims the priority benefit of Canadian patent application 2,707,411, having the same title and inventor, and filed with the Canadian Intellectual Property Office on Jun. 11, 2010, which application is incorporated by reference in its entirety.

### TECHNICAL FIELD

This invention relates to the distribution of prescription pharmaceuticals and over-the-counter (OTC) medications, and to the field of services accessed over the internet.

### BACKGROUND

Canadian patent application 2,518,284, entitled Prescription Drug Distribution and Methods, refers to secure methods and systems for issuing and filling prescriptions. U.S. Pat. No. 7,630,908 is a pharmaceutical system in which pharmaceutical care is provided by a remote professional serving multiple pharmacies. The technology involves portable digital assistants (PDAs) and bar code scanning technology. Website services in the field of pharmaceutical development include Kiosk Europe, run by HF Network Ltd. out of Cambridge, UK, and Pharmatrust, run by PCA Services Inc. out of Oakville, Ontario. None of these prior technologies provide the combined advantages of the invention described here.

### SUMMARY OF THE INVENTION

This invention allows a mail order pharmacy and a network of community pharmacies to provide a service whereby customers place orders for prescription medications & other products online or from conveniently located terminals.

One embodiment of the invention is a computer-implemented method for delivering prescription pharmaceutical products. This typically involves inputting information for a prescription drug for a particular pharmaceutical product to be dispensed for a particular consumer by way of an electronic kiosk, authenticating and verifying both the provided prescription and the consumer's identity, collecting the original prescription form, and then causing the product to be delivered or otherwise be made available to the consumer when the original prescription form has been obtained from the consumer or his/her prescriber. Alternatively, a request to dispense a particular pharmaceutical product for a particular consumer can be received over the internet, following which the original prescription form is collected at a kiosk before the product is delivered.

Another embodiment of the invention is a computer system adapted or programmed to perform a prescription dispensing method of the invention. The system typically has dedicated electronic kiosks adapted to read information from a prescription form, and/or to collect and secure the original prescription form from the consumer, and a back-end processing system for dispensing pharmaceutical products based on information received from the kiosks.

Another embodiment of the invention is a remote pharmacy ordering terminal or electronic kiosk for ordering pharmaceutical products and/or collecting prescription forms. The kiosk may have a device or component for obtaining prescribing information from a prescription form written for a particular pharmaceutical product to be dispensed for a particular consumer: specifically, prescribing information comprises the identity of the consumer, the identity of the pharmaceutical product(s) to be dispensed, the prescribed dosage, and the frequency the product is to be taken by the consumer. The kiosk may also have a device or component for identifying the consumer, a way of sending the prescribing information to a back-end processing system, and a computer processing unit for managing the components of the kiosk in accordance with the invention. In some embodiments, the kiosk has a compartment for receiving and securing prescription forms. Once each form has been collected from a consumer ordering a pharmaceutical product by way of the terminal, the pharmaceutical product can be delivered to the consumer.

Another embodiment of the invention is method for providing medication to a particular consumer having a prescription for said medication. This involves receiving information regarding a particular pharmaceutical product to be dispensed to the consumer; and delivering the pharmaceutical product to the consumer once a computer system of this invention has verified the consumer's identity and that the prescription is from a licensed physician.

The computer implemented method, computer system, remote ordering terminal, and delivery method of this invention can be adapted to receive orders and provide consumers with products for which a prescription is not required. Depending on what the vendor wishes to supply, such non-prescription products may include over-the-counter medicines, cosmetic items, and/or other retail goods of any kind. Non-prescription items are ordered and processed in a similar fashion, except that a prescription form need not be collected before the non-prescription products are delivered or otherwise made available to the consumer. The non-prescription products may be ordered and provided either by themselves, or simultaneously or in conjunction with prescription products.

Further embodiments of the invention will be apparent from the description that follows.

### DRAWINGS

FIG. 1 is a line diagram showing a model of a dedicated Remote Ordering Terminal

FIG. 2 is a flowchart providing an overview example of the ordering system.

FIG. 3(A) is a flowchart showing a new registration process.

FIG. 3(B) is a flowchart showing a patient profile update process.

FIG. 4 is a flowchart showing a product ordering process.

FIG. 5 is a flowchart showing a prescription form verification process.

FIG. 6 is a flowchart showing remote pharmacy back-end processing.

FIG. 7 is a flowchart showing central product fill to other pharmacies.

FIG. 8 is a flowchart showing the transfer prescription process from other pharmacies.

FIG. 9 is a flowchart showing the search drug/product process.

### DETAILED DESCRIPTION

This invention relates generally to methods of ordering prescription drugs in compliance with all current regulatory requirements. Features include ordering of prescription medications as in regular community pharmacies and on-line mail order pharmacies. The Remote Ordering Terminal can be used instead of face-to face-pharmacist interaction. Therefore, the customer gets what is expected from a regular pharmacy without sacrificing any technical or regulatory requirements.

### Overview

With the advent of mail-order and online (internet accessed) pharmacies, all medically prescribed prescriptions including controlled medications (narcotics) and temperature sensitive medications, as well as non-prescription drugs (over-the-counter or OTC medications) along with general health and beauty aids, can be shipped to customers within 2 to 5 days by regular mail or overnight by an express courier service for a price. They can even be picked up from a pharmacy location. The immediate delivery of medications upon submission of a valid prescription that meets regulatory requirements, along with the ability to order medications remotely 24/7, are two aspects of the service achieved by this invention.

A Remote Ordering Terminal according to the invention described here can verify information about each pharmaceutical consumer: Their name and address; their medical conditions; any allergies or drug sensitivities; other medications taken; payment method; and delivery options. It can also meet the following regulatory requirements:
Delivery of a valid original prescription (particularly for controlled and narcotic medication), or a faxed, phoned or electronically submitted prescription from the doctor's office
Verification of the doctor's information including the doctor's name, license, telephone and fax numbers
Safe dispensing of medication (checking the suitability of dispensed medication, drug allergies, duplicate therapy, drug contraindications and suitable dosing), along with
Patient counseling before or simultaneously with the dispensing of the drug.

Previous technology failed to meet these criteria, either by restricting dispensing to certain medications such as life-style medications, or by generating electronic prescriptions to facilitate the dispensing from the ordering terminal which is not in compliance with current regulatory requirements. Other systems carry only a limited amount of drugs for immediate dispensing via video communication with a remote pharmacist, and are only suitable in certain settings such as doctor offices or point of care locations. These systems require a person to verify that submitted prescriptions are original and not a photo copy. Furthermore, they can dispense a very limited number of standard sized drugs. Hence, these previous systems lose their convenience and cost effective objectives and do not preserve the customer's privacy.

The Remote Ordering Terminal allows a customer to enter their personal information and home address which is automatically verified against a public database for correctness and authentication. In addition, specific data used for back-end dispensing verification are also collected including their medical information (e.g. drugs taken, allergies, and medical conditions). Additional data such as the attending physician name and phone number is also entered and subsequently verified against relevant databases. The customer's local pharmacy name and phone number is collected in order to facilitate two-way transfer of prescriptions if required. Therefore, the central pharmacy may transfer prescriptions from the customer's local pharmacy upon their order to be filled and shipped from the central pharmacy or vice versa. The customer may also pick up emergency medication from their local pharmacy upon transfer from the central pharmacy. At the end of the registration process, the customer's signature and image are obtained and stored at the server side. The customer is then logged in automatically to a secured Internet session (SSL) and can proceed with ordering their medication.

A customer may search for the desired medication or OTC product and obtain its cost, or log in, if not already logged in, and order the selected medication or OTC product using an electronic shopping cart. A customer may order using their prescription without knowing the name or particulars of the medications prescribed for him. The electronic shopping cart processes the customer's order after collecting payment methods and shipping address or delivery options, which are both automatically verified. The ordering is completed by scanning the customer's prescription, when provided, and collecting it inside a secured locked container for subsequent retrieval and delivery to the central pharmacy. Alternatively, a request for prescription with order number is given to a customer to ask their doctor's office to phone or fax or electronically submit their prescription directly to the central pharmacy.

Moreover, as an alternative to a dedicated terminal, the system is set up so that a customer may use any computer with an internet connection to process their order as explained above. Later, they can deliver their original prescription to any Remote Ordering Terminal by logging in to their account, entering the online order number, and scanning and delivering their prescription as described above. During the ordering process, a customer may chat on-line with the central pharmacy or use the IP phone handset to talk to a customer service representative (CSR) or pharmacist for counseling. Every time someone uses the Remote Ordering Terminal, an embedded camera records and stores their image for security purposes. This is done to enhance the security of both the customer and the terminal.

The back-end server and processing centre collects all data and images into a database that is accessible to the central pharmacy staff for filling and shipping the order. Original prescriptions are received by the processing pharmacy or collected from the terminals on a daily basis or whenever originals are detected, and then matched with electronic orders and images using bar-codes before a filled order is released for shipping. As matching with original prescriptions is often required to confirm the authenticity of the electronic order, this process confirms and meets all of the regulatory requirements. Furthermore, the back-end system runs periodic refill-reminders to all customers in order to refill their medication before they run out, and promptly ships it when they are due.

A Remote Pharmacy Ordering Terminal can be used instead of a community pharmacy or a network of pharmacies, and provides a convenient 24/7 location for customers. Customers can order all their prescription medications and OTC products (including controlled and narcotic medications), and the system collects their original prescription forms in the process. Customers conveniently receive their medication at the address of their choice in a short time, while complying with all regulatory requirements.

### Benefits of the Invention

The Remote Ordering Terminal allows the consumer to order prescription and non-prescription medications using a remote terminal (a kiosk) that is conveniently located inside or outside a licensed pharmacy. The terminal is used to collect the customer's data and their prescription while the central pharmacy back-end processing system instantly verifies the correctness and authenticity of any entered data and orders. Furthermore, the terminal is set up to collect the original prescription for retrieval by the central pharmacy before shipping/delivering the medication to the customer, thus verifying that an original prescription has been used to support the customer's order. In addition, the terminal is set up for private and instant communication with the central pharmacy CSR and pharmacist using Instant Chat and IP telephony for customer support and counseling. Furthermore, an embedded camera is used to record the customer's image for security purposes. Order processing and verification are typically done by back-end servers through internet communications.

This ordering terminal is configured to meet all the regulatory requirements of both the Pharmaceutical regulatory authority as well as the Medical Physician regulatory authority. Therefore, no restrictions are imposed on the type or class of drugs and medications that can be ordered using the terminal, or the time of operation and the location of the terminal. This is due to the fact that no medication will be shipped before the retrieval and verification of original prescriptions—exactly the same way an order is processed by any face-to-face interaction at a community pharmacy location. The difference here is that verification is done on-line, and the customer order is accepted or rejected promptly at the terminal. Delivery instructions are given to the customer upon completion of their order in accordance with the type of drugs ordered as well as the customer's preferences.

### Hardware

The drawings provided with this disclosure show working embodiments of the invention that illustrate potential features and benefits. Except where explicitly stated or required, the features of the drawings are not intended to limit the invention in the claims presented below.

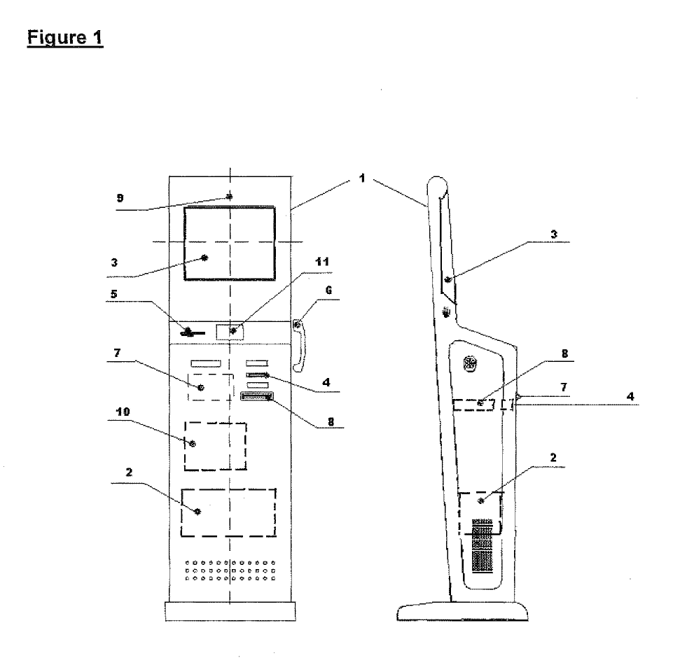

FIG. 1 shows a model that illustrates the Remote Pharmacy Ordering Terminal of this invention. There is a mounting stand-Chassis (1) housing a standard hardware computer and secured Rx Collection Box (10). The Terminal Computer (2) includes a mother board with mounted CPU/Micro-Processor, Memory and Peripherals interfaces. The peripherals include an LCD Monitor with touch screen functionality (3) for display and to accept user input. Also, there is a Card Reader for Credit and Insurance Card data entry by swiping the card (4), a Plastic Pen (5) for customer signature entry and/or Touch Screen entries, a key pad (11), an IP phone hand set for telephone communication with Central Pharmacy CSR or pharmacist (6), a Scanner to scan prescriptions (7), a Printer to print receipts with their order confirmation and order number for subsequent follow up with the Central Pharmacy (8). In addition, the following hardware is used to operate the terminal effectively; Hard Drive to store the operating system and non-private data, embedded Camera (9) to capture customer/user images for security and verification purposes, 3G wireless Card with SIM adaptor for wireless internet connection, Power supply to convert 110/220 VAC power to proper DC power suitable for the electronic hardware, and a UPS (Uninterrupted Power Supply) to handle short interruption of AC power and for normal shutdown of the terminal hardware in case of a long interruption of AC power.

### Remote Ordering Process

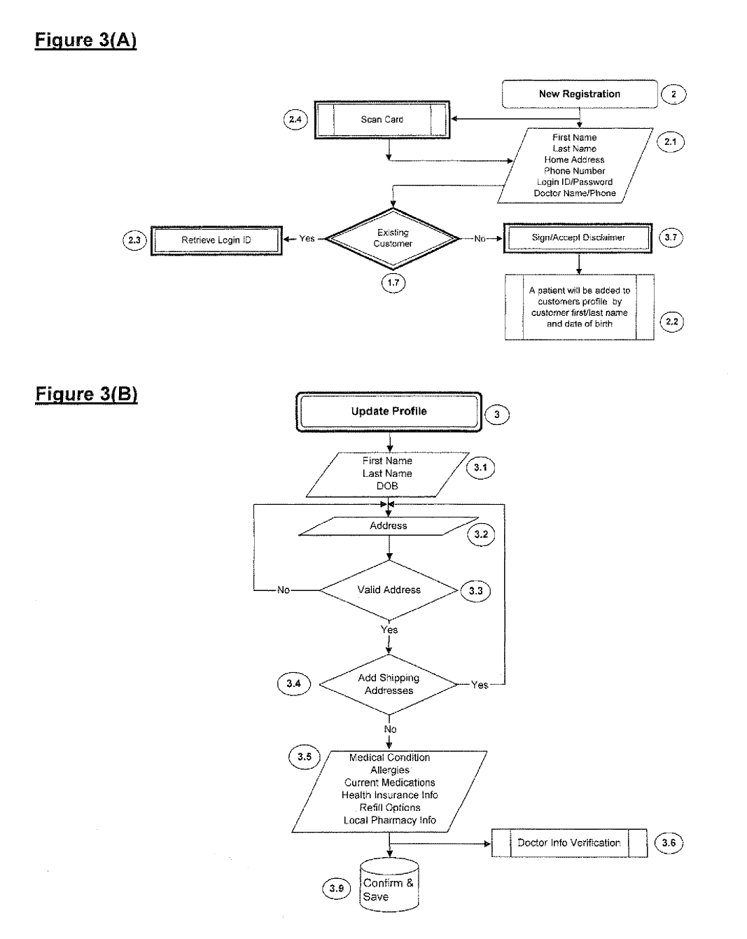

Ordering of prescription medications or non-prescription OTC products is done using an Internet browser and SSL (Secured Socket Link) Internet Protocol with all the typical security measures. This provides secure data transfer of customers' personal, medical and financial information to the Central Pharmacy back-end servers which host order processing databases and order processing programs as well as software applications. Any computer with an internet connection and proper browser version can be used to register and place orders (FIG. 3(B)).

However, since the customer who is placing an order using a computer at home or office cannot deliver the original prescription as required by regulatory bodies, instructions are given to the customer to mail the original prescription or ask their attending physician office to directly fax or phone it to the central pharmacy (faxing does not apply for controlled and narcotics prescriptions). Additionally, when the customer knows their own repeated maintenance medication and orders by selecting their drugs, the system generates a “Request for Prescription” form with details of the customer's order for their attending physician modification, signature and faxing to the Central Pharmacy.

At the Central Pharmacy, received prescriptions (either mailed originals or faxed copies from doctor offices) are matched with electronic orders in the back-end processing system, and order delivery takes place in accordance with business rules and customers' needs. Orders made using a consumer's own computer by way of the internet are similar to orders made using the Remote Pharmacy Terminal, except the Remote Terminal is capable of instantly transmitting an image of the prescription. The customer's image and his signature are transmitted to the Central Processing Pharmacy which collects the original prescription for subsequent retrieval and matching with the customer's order at the back-end (4.11) before delivery to the customer.

This is an added convenience to the customer, as he or she does not need to visit the pharmacy or mail their prescription, thus the medication delivery processing time is reduced at the central pharmacy. This feature is also used to collect original prescriptions for orders made at any computer other than the Remote Ordering Terminal, thus providing the customer with the convenience of ordering prescription medication on-line at any location then dropping the original at the nearest Remote Ordering Terminal, thereby saving the customers the mailing time.

In order to use Internet SSL protocol, a customer has to register on-line and provide a User Name and Password to log in to the secured back-end servers. A pre-registered customer can simply log in any time to use the system to order new prescription drugs, refill existing prescriptions, transfer a prescription from another pharmacy, and check the status of his/her orders or order OTC products. A newly registered customer will be automatically logged in and directed to the SSL back-end servers to proceed with the ordering process.

### Registration and Log In

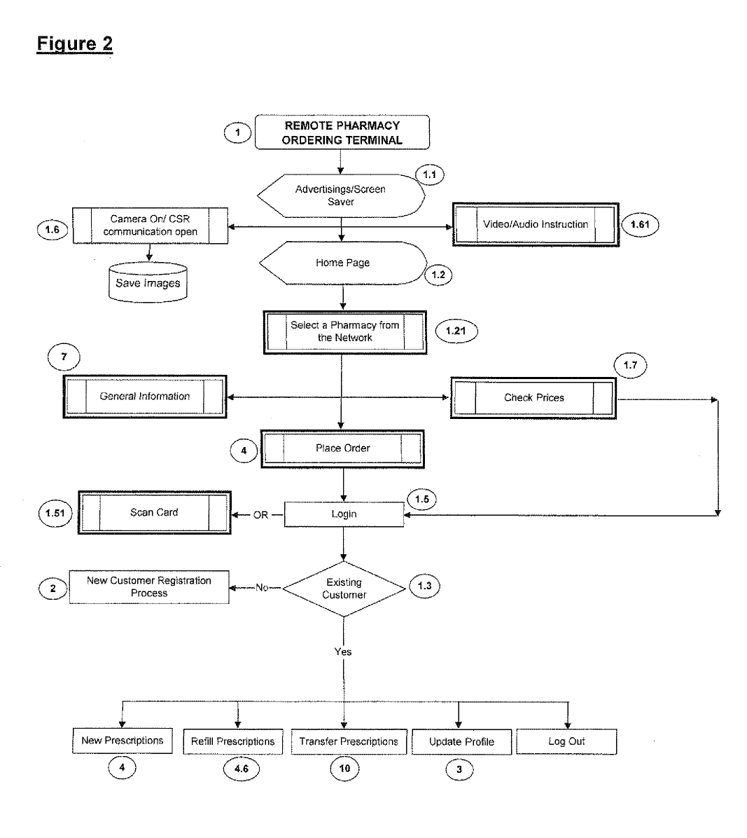

FIGS. 2 to 7 provide flow charts for the various working components of the model system.

Referring to FIG. 2: While the Pharmacy Remote Ordering Terminal is idle or not in use (1.1) public advertisements and pharmacy announcements run automatically and sequentially. This is to attract attention of passing-by public and can be used to generate additional revenue from advertisers.

Once the terminal screen is touched the Pharmacy Home page is displayed (1.2), the home page has all links and instructions to use the Ordering Terminal. Meanwhile, the first screen touch triggers the embedded camera to start recording the image of the user (1.6), the recorded images are stored locally on the hard disk and can be accessed by the CSR Customer Service Reprehensive on command or while in communication with the customer on-line. The customer has the option to use the instant chat to initiate the communication with CSR, alternatively the CSR can also initiate a communication with the customer to help place their order, and a telephone hand set is available for the customer to start a conversation with the CSR or pharmacist in the central pharmacy. These communication methods are used for customer support and pharmacist counseling.

In the event that a network of pharmacies participate to offer their services from the Remote Ordering Terminal, a pharmacy selection page (1.21) is used to direct the ordering process to the selected pharmacy which can be different from the Central Processing Pharmacy. In this case, a unique envelope serial number is assigned to the placed order (5.8 & 5.9) during prescription collection for subsequent sorting process (6.4) and forwarding to the selected pharmacy. Meanwhile, a video/audio instructional clip related to each user selected page is always running to assist the user in operating and selecting the proper choices on each screen.

A customer can check prices of prescription drugs and non-prescription products any time from the home page (1.7). Even more, a customer can check general information about ordering on-line, policies, promotions and instructions or use the Virtual Pharmacist link to get answers for medical questions. See the Adv-Care® Pharmacy website. A customer can start ordering any time while browsing the home page and the related product links from the home page (1.2). Once the user tries to add a product to the shopping cart, the system prompts him/her to log in (1.5) or register his/her personal data if s/he is a first time user (2). As the customer registers by entering his name & date of birth, the system checks if the customer is existing in the Central Pharmacy database and prompts him/her to retrieve his/her original User name & Password or contact a CSR for assistance (2.3).

Referring to FIG. 3(A): In the registration part of the process, a new Registration form is presented to the customer through SSL link from the back-end server (2.1) in which the customer enters: First and Last Name, E-mail address, Date of Birth, Home Telephone Number, User Name and PIN/Password, and Home Address. Alternatively, a customer may swipe his driver's license card or government health card to automatically populate the registration form (2.4). Any official ID card with magnetic strip can be used.

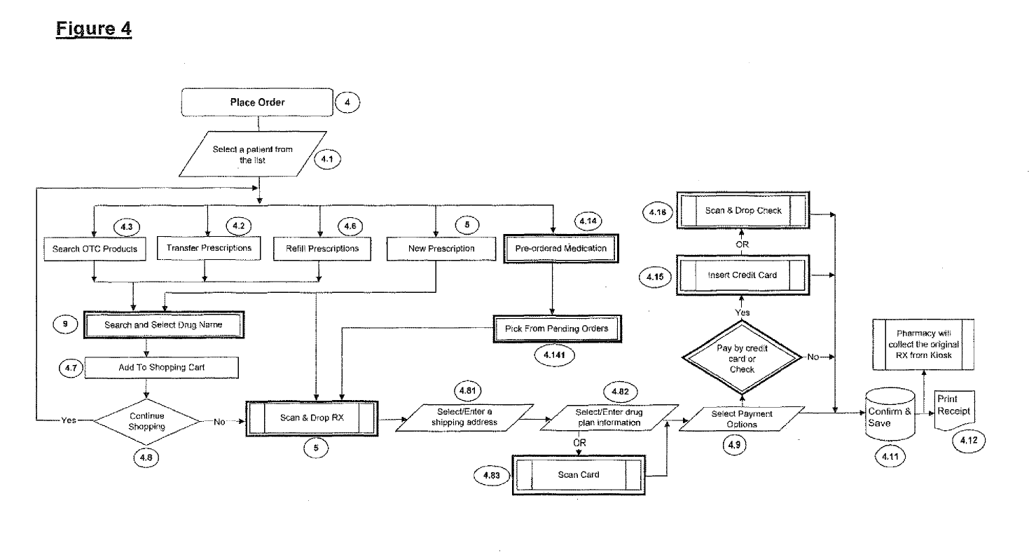

If the selected product is an OTC (non medication) product (FIG. 4), no further data is required. The ordering process is completed by directing the customer to enter the shipping address and payment method. If the shipping address is different than the home address, a new address is entered into the customer's address book. Every time an address entry is made the back-end application verifies the correctness of entered data against public databases such as Yellow pages or “411” directories (3.3). Any error is prompted back for customer correction. Therefore, all phony orders are eliminated and any shipping/delivery problems are corrected.

Referring to FIG. 3(B): A new registration form is also a profile modification form. It is used to collect all customer medical data through SSL pages particularly when a customer selects a prescription product. A customer is prompted to enter their first Name, Last name and Date of Birth (3.1). The back-end server checks if the customer exists in the database and prompts him or her to log in or recover their log in PIN/password after answering personal questions and verifies that the answers match the customer profile data. The customer may also seek CSR assistance to reset his/her PIN/password (2.3).

If the customer successfully logs in, the system retrieves from the database all previously entered data to allow the customer to modify any old data. If the customer is new, the form is used to add his/her data into the back-end database. The data required, in addition to First/Last Name, User Name, PIN/Password and security Question and Answer, is home address and contact information (3.2). This includes: Home Telephone Number, Day Telephone Number, Street Address, City, Country, and Postal/Zip code.

The back-end system verifies the correctness of entered data and prompts the customer to correct errors. The verification is done by cross checking public directories of addresses and telephone numbers. If shipping address is different from home address, the customer can proceed to enter their shipping address (3.4) during ordering process (4.81) and the back-end system instantly verifies the address as before.

Next, the customer proceeds to enter their medical data. A drop-down menu is used to present possible data for the customer to select from, these data are coded as per standard pharmacy prescription filling programs, so no errors are allowed into the database and pharmacy filling is accurate and fast. Section (3.5) lists all data fields required and entered during the registration process. Namely: Medical Conditions, Drug Allergies, Current Medications taken, Health Insurance plan name and numbers, Refill Reminder options, as well as local Pharmacy Name and Telephone Number. Medical information and options may also be added to the customer profile during ordering or from any computer with an internet connection when the customer accesses his/her profile anywhere. Subsequently, the customer proceeds to enter their doctor information (3.6) comprising Doctor Name and Telephone Number. The back-end system verifies the correctness of the Doctor information by cross checking with a verified physician database.

At the end of the registration process, the customer is presented with a legal disclaimer and is prompted to sign their registration using the plastic pen on the terminal touch screen or signing pad, or simply accepts the disclaimer. The back-end system stores all entered data signature and customer image in the database, and confirms the registration to the customer (3.9). After a new customer successfully registers, the system automatically logs in the customer to the back-end server and allows access to the shopping cart.

### Placing Prescription Orders

Referring to FIG. 4: A customer can place an order for themselves or as a caregiver for a family member. Every person has a unique profile with a unique User Name and Password stored in the back-end database. Therefore, a caregiver can add to his profile all his family members during the registration process page (3A) or while ordering. When a caregiver places an order, the back-end server presents all listed family members in his profile to select which family member he is ordering for (4.1). The back-end system automatically logs him to the selected family member's profile before the customer proceeds with ordering and subsequently stores the order data into the family member's profile.

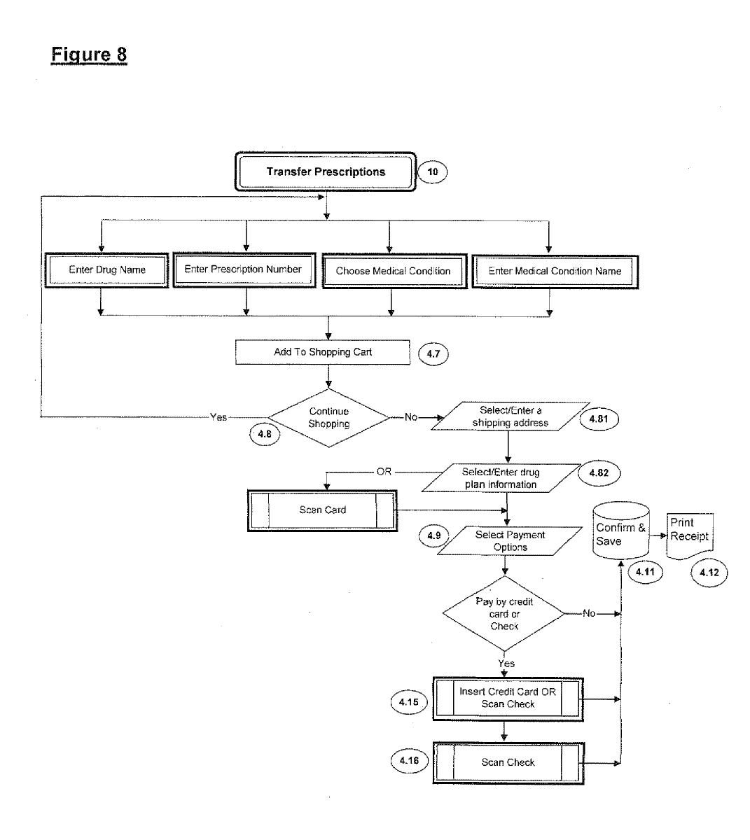

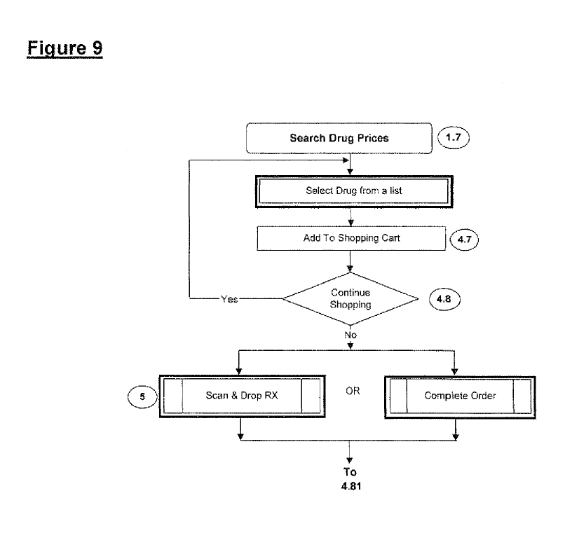

The customer order comprises products added into a shopping cart. Products can be either of/or combination of the following order categories:
OTC or non prescription product selected from OTC products list (4.3)
Prescription product selected from prescription products list (1.7) & FIG. 9
Using original prescription image without product selection (5)
Selecting a prescription medication from the list of drugs to transfer a prescription filled at another pharmacy (4.2) & FIG. 8
Pre-ordered medication placed from a computer other than the Ordering Terminal (4.14)

Every time a selected product or a product category is added to the shopping cart, the customer has the option to add more items until satisfied (4.8), when done the customer can select to pick-up or select a shipping address from his/her entered list or add a new shipping address for the order in hand (4.81).

At the end of ordering, an estimate of the order cost is given to the customer. In the case where products are selected from the database through the search feature, a final cost is billed (according to the doctor prescription which may vary from customer selected medication and doses) and sent to the customer with his medication. For the next step, the customer is prompted to enter payment methods (4.9). The customer has a choice of using any method of the following for their full payment or insurance co-payment:
Credit Card
COD (Cash on Delivery)
Check
Other (phone-in, fax-in or PayPal® online payment system)

A card reader is located in the Remote Ordering Terminal and can be used to swipe the Credit Card and/or the Insurance Card (4.15). The resulting reading is transmitted scrambled to the back-end server and stored in scrambled format in the database. When the credit card number is entered into the payment form, the back-end system verifies the correctness of entered data before accepting the payment method. Also, a personal check can be scanned, verified and dropped into the terminal (4.16). Customers may also scan a health plan or drug benefit card (4.83) to make use of their health plans when paying for their orders.

At the end of the ordering process, the customer is prompted to scan his prescription (4.10). The scanner employs an OCR (Optical Character Reader) application to convert the image into readable words/text. If no characters/text are read, or if the customer is unsatisfied with the image the scanner assumes the prescription has been scanned upside-down or scanned bad image (5.2), it reverse the scanner feed and prompts the customer to turn the prescription over or try to rescan again. If the second scan results in the same unreadable characters, it assumes the order is phony and rejects the order. The scanner feed control can be remotely invoked allowing customer service operators to view the prescription image and give the prescription back to the customer in case emergency medication is prescribed and the customer requires immediate pickup for example.

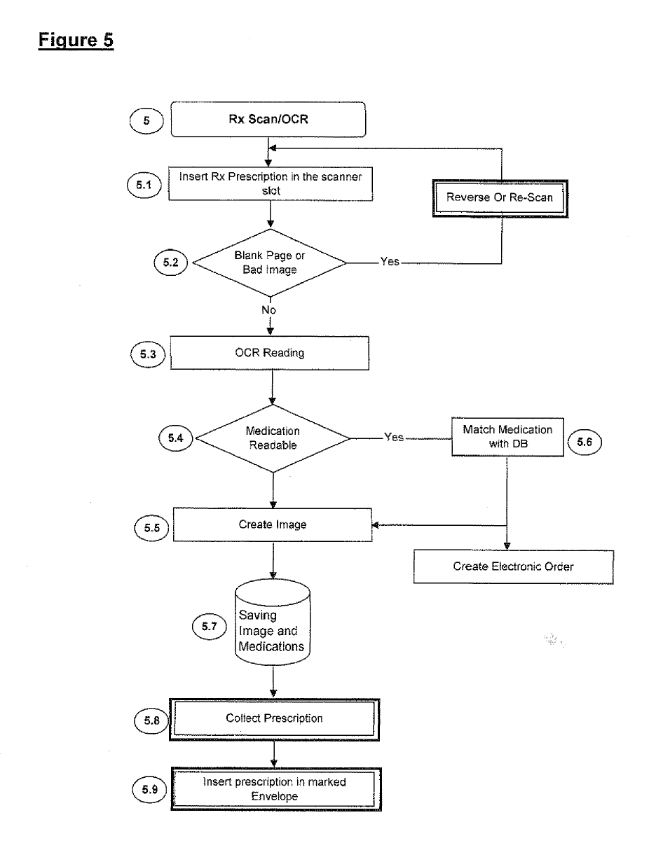

FIG. 5 illustrates the OCR verification of a Scanned Prescription. An OCR application built into the Remote Ordering Terminal or back-end server scans a prescription image and converts the image into text. The text is cross-checked against the drug database and known keywords. In the case of typed prescriptions, if the OCR successfully read the text after a prescription scan, and this text is matched with any medications in the products list, the application will fill in the ordering table or form with the recognized medication and present the order to the back-end system to be processed electronically after pharmacist verification of the prescription image (5.3). However, if OCR is unable to recognize the written medication, it proceeds with the ordering process without filling the ordering table/form with any medication. A pharmacist at the Central Pharmacy will then read and manually enter the text to fill the medication from the stored image.

The Remote Ordering Terminal can be configured to accept orders and prescriptions from a network of participating pharmacies. In order to accurately match original prescriptions with their electronic orders, bar-coded envelopes with unique numbers are supplied to the customer to enclose his/her prescriptions along with other papers, such as personal checks if used. The customer then drops the envelope into the terminal safe for later collection and sorting using a bar code application at the central pharmacy (5.8,5.9). This ensures matching accuracy (6.4) and privacy requirements.

At the end of the ordering process, the Remote Ordering Terminal will print a customer receipt containing his/her order number (4.12). The original prescription is retained in a secured container with a key-lock and built-in one way paper entry (4.13). Also, it reads the bar-coded envelopes to be used when matching the retrieved prescriptions with the customer's order at the Central Pharmacy (4.13).

FIG. 8 shows a transfer prescription order process showing the options a customer can utilize to help indicate which medication is required to be transferred. Such information can be easily understood by the pharmacist to officially request the correct transfer.

FIG. 9 illustrates the ordering process using the search/select a drug or a product from the database. When no prescription is delivered a “Request for Prescription” instruction is printed at end of ordering (4.12) to assist the customer's physician in submitting the prescription directly to the pharmacy.

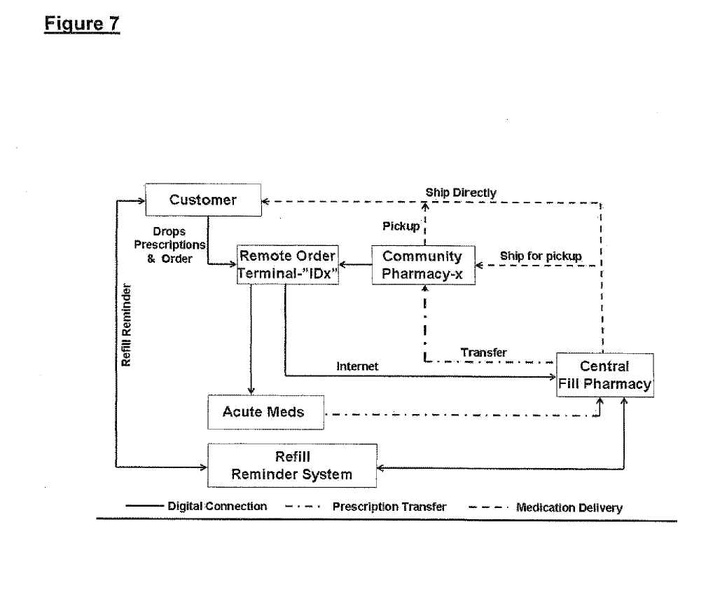

FIG. 7 illustrates the central pharmacy fill process using the remote ordering terminal for independent community pharmacies. As described, The Remote Pharmacy Ordering Terminal is used to generate customers' orders for a Central Processing Pharmacy. These Ordering Terminals can be identified individually with a Terminal ID Name, which is used to identify its location and its function. The Terminal then can act, in this setup, as an ordering terminal for other Community Pharmacies or even a third party where the central pharmacy can fill prescriptions on their behalf or merely act as an extension to the community pharmacy. Therefore, the community pharmacy can position the Remote Ordering Terminal in its premises or in the vicinity of its premises to serve their own customers while it is closed (after business hours) or during high volume/demand. The Central Pharmacy operating the Remote Ordering Terminal appears to the customers as their own community pharmacy and the orders generated by these Terminals can be sent directly to the community pharmacy for filling, or filled at the Central Pharmacy on behalf of the community pharmacy and shipped directly to the customer or to the community pharmacy for customer pickup.

In the case where the Community Pharmacy is filling their own customer's order, the Central Processing Pharmacy will act to provide pharmacist counseling, customer service and assistance in using the Terminal to collect customers' orders or prescriptions & profile. A simple digital notification is sent out to the community pharmacy system, including the details of the customer order, to retrieve the customer's prescriptions and their order's instructions from the Terminal to be filled and processed in their own pharmacy system.

In the case where the Central Processing Pharmacy is filling the prescription on behalf of multiple community pharmacies or a third party, the following requirements will be in effect: Each Ordering Terminal will be identified with an ID name (for example IDx) that defines its location and its function, each prescription enclosed in bar-coded envelope will be linked to the electronic order, so that all orders generated by a terminal can be identified and processed differently at the back-end and shipped to the community pharmacy for customer pickup under Central Fill agreement defined by the regulatory body in the country of jurisdiction, or simply shipped directly to the customer's address depending on their order instructions and consent.

The Central Process Pharmacy can employ the Automated Refill Reminder system to enhance customer convenience and improve patient compliance. The system sorts all orders in the back-end database and determines when a customer is due to receive their prescription refill. Also, the system identifies how long it takes to ship the medication to that customer depending on the following factors:
Customer location relative to the Central Processing (fill) Pharmacy
The Community Pharmacy Location relative to the Central Processing Pharmacy in case the customer is picking up their medication under a Central Fill Agreement
Whether the customer has authorized refills on file or he/she needs to visit their physician for a new prescription.
An extra time period is allowed for the customer to respond to the reminder.

Accordingly, a varied average number of days is deducted from the customer's “due time to receive his/her medication” to determine the date to initiate each customer's reminder. A customized telephone message with a hot link to the central processing pharmacy is broadcasted in the determined Reminder time, where a customer can:
Use the hotlink feature to talk to the customer service and confirm his/her order
Call back at his/her own convenience to order his/her refill medication
Electronically confirm his/her refill orders on file using the telephone dialing pad; or
Visit his/her attending physician to obtain a new prescription.

Alternatively, a customer can log in to his/her profile at the ordering terminal or at a computer connected to the Internet to view his/her past ordered medication as well as available refills, and then order refills of the medications of his/her choice (4.6). Every time a customer is ordering the system checks for due refills & advises the customer to include them in his/her order.

### Back-End Processing

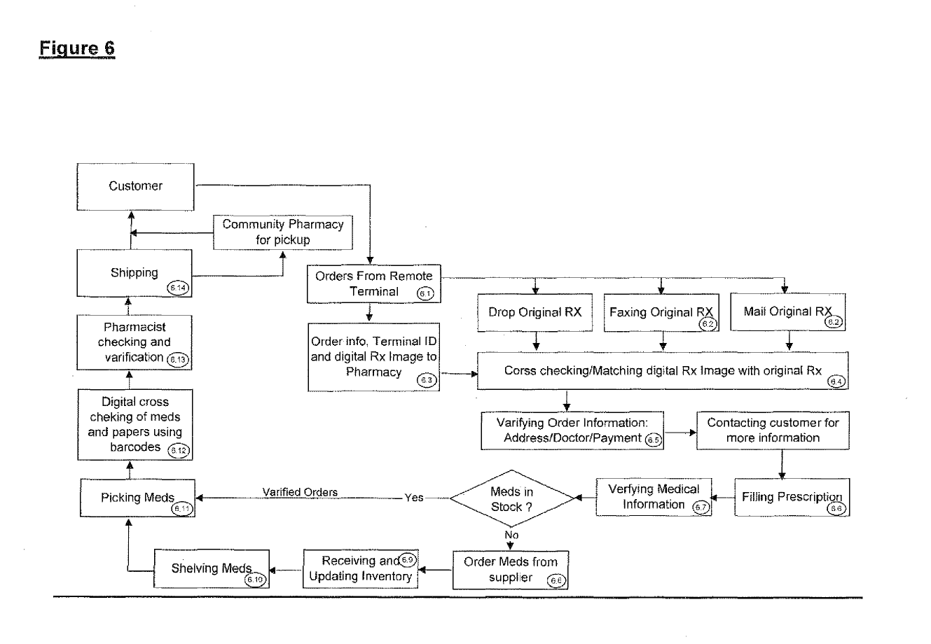

FIG. 6 provides an illustration of the Central Processing Pharmacy's back-end system. There is a Central database, Processing applications and Pharmacy filling application. The Back-End processing system is described in summary to illustrate the stages required to process orders received from the Terminals and shipped to customers.

All orders sent to the back-end system are generated with a unique order number that identifies the customer profile and the transmitting Order Terminal. Prescription images are also stored in the database with the unique relevant order number. The Back-End system receives orders from a variety of sources in different formats; on-line including Ordering Terminals, mail, fax, e-mail and phone (6.2). Prescriptions also are received at the back-end in different formats; ordering Terminal's Image, electronic prescriptions from doctors—when approved, faxed or mailed original. The retrieved original prescriptions from the Ordering Terminals are enclosed in bar-coded envelopes or stamped with their relevant order number which is used to match with the electronic order summary sheet generated by the system (6.3).

Faxed prescriptions from doctor offices and original prescriptions are matched by searching the database for the patient name and order number and attaching originals and faxes to order summary sheets containing the bar-code representing the “order number” (6.4). After matching prescriptions with orders, all relevant data is checked so that no order should move forward unless all medical data is confirmed and entered in the database (6.5). Complete orders and original prescriptions are used to fill the orders in the standard pharmacy system (6.6) as a standard filling process, such that medical conditions, duplicate therapy, correct dosing, drug allergies and contraindications are verified (6.7).

On a daily basis, the back-end system generates a summary of drugs to order from manufacturers to satisfy all filled customers' orders (6.8). Received drugs are scanned and reconciled with the ordered quantities; any discrepancies are recorded and corrected with the vendors (6.9). Verified customers' orders are used to pick the drugs from the inventory shelves (6.11)

An inspection station receives all order paperwork as well as picked drugs that are collected in bins. Each bin contains a customer's receipt, medication label, instructions, shipping label and the order summary. Each piece of paper is generated with a bar-code identifying its function and the order number. All bar-codes are scanned and the back-end system verifies that the order components are valid and conforms to the customer's order and filled prescription (6.12).

Before any order leaves the premises, the pharmacist makes a final check of the order components against the original prescription and affixes labels on the medication bottles and packs all order components in a correctly labeled shipping package (6.13).

The Back-end system produces the shipping labels from the customer's shipping instructions and address. It also identifies Central Fill orders that require shipping to community pharmacies for customer pickup (6.14). Finally, the customer receives his/her order and signs for it. The postal or courier service normally provides shipment tracking which is captured by the back-end system and added to the database as confirmation of delivery to the customer.

### Advantages Over Previous Technology

The technology described in U.S. Pat. No. 7,630,788 involves remote dispensing robots inside pharmacy premises which are controlled by remote pharmacist. A licensed pharmacy remains open without a pharmacist present in the store. The invention described here is superior in several ways, including security, conformity to regulatory requirements, and the ability to distinguish between an original prescription and a photocopy.

The technology described in Canadian patent application 2,518,284 generates a physician's prescription for each consumer without a direct relationship with the prescriber. The focus is on so-called lifestyle drugs. The invention described here is superior in several ways, including its ability to verify a customer's identity and information, and to conform to regulatory requirements.

The technology provided by Kiosk Europe involves kiosks placed only inside pharmacy premises. It does not provide customers with direct and immediate access over the internet to customer service. The prescription is physically processed and picked up by the customer several days later. The invention described here is superior in several ways, including its ability to be more widely available and provide more informed and more immediate service.

The technology provided by PharmaTrust is focused on improving communication between patients, physicians and pharmacists. A limited number of specially packaged medications, which apparently do not include controlled drugs, drugs that need to be stored at low temperature, or drugs formulated in liquids or creams. The invention described here is superior in several ways, including its ability to provide a wider range of pharmaceutical products that includes all of these products and verifying original prescriptions before dispensing.

### Features of the Invention

In summary, the invention described here provides an on-line pharmacy ordering system for ordering Prescription drugs and Over the Counter Products (OTC). It may have any or all of the following features in any combination.
The system can manage products, descriptions, and pricing managed by IBM's Net-Commerce shopping cart and supported by on-line servers in a Central Pharmacy which receives plurality of orders to be processed by itself or on behalf of other pharmacies
A customer's ordering interface can be provided through an Internet Browser using client-server access technology.
A back-end application running at the server end verifies customer's entered data by cross checking available pharmacy and public databases for correct customer's address and telephone numbers, Doctor's Name, license, telephone and fax numbers, Credit Card number, and private Insurance data.
The Back-end Server can be configured to provide the customer's with coded medical conditions, Allergies and entry of Medications used. Data entered by the customer is further used to check the safety of dispensed prescribed medications or over-the-counter products: for example, Drug Interaction, Contraindications, Duplicate Therapy, Drug Allergies, and Correct Dosing.
The Remote Pharmacy Ordering Terminal can be configured as an Internet based client using an Internet Browser to provide the interface for the customer to enter data required by the Central Pharmacy Back-End server.
The Remote Pharmacy Ordering Terminal can be configured to receive only customer orders and collect and store their original prescriptions for subsequent retrieval and delivery to the central pharmacy to fill the order and ship medication to the customer. No medication dispensing from the Remote Ordering Terminal takes place.
The Remote Pharmacy Ordering Terminal can include an embedded camera to capture image of persons using the Remote Ordering Terminal to enhance security at the terminal.
The Remote Pharmacy Ordering Terminal can include a touch screen to facilitate data entry.
The Remote Pharmacy Ordering Terminal can include a credit card reader to facilitate collection of payment method.
The Remote Pharmacy Ordering Terminal can include a pen and electronic signing pad to facilitate collection of customer's signature.
The Remote Pharmacy Ordering Terminal can include a scanner with forward and backward movement control to facilitate capturing the prescription image and control its acceptance or rejection.
The Remote Pharmacy Ordering scanner can be used to scan customer's personal check or Health Plan card and collects it as a form of payment.
The Remote Pharmacy Ordering Terminal can include a telephone hand set to facilitate IP telephone communication with the central pharmacy Customer Service and pharmacist.
The Remote Pharmacy Ordering Terminal can include a printer to print customer's receipt and order number.
The Remote Pharmacy Ordering Terminal can include an instant text and call back application to facilitate customer's assistant and communications with central pharmacy
The Remote Pharmacy Ordering Terminal can be configured to store all website images locally to reduce internet data exchange with Back-end Server.
The Remote Pharmacy Ordering Terminal can include a locked and secure replaceable box to collect and store scanned prescriptions.
The Remote Pharmacy Ordering Terminal can be configured to run pharmacy advertisements and announcement while idling.
The Remote Pharmacy Ordering Terminal can be configured to accept prescription orders without knowing the ordered medication/s by scanning the prescription image.
The Remote Pharmacy Ordering Terminal can be configured to connect to the internet using wireless communication.
The Remote Pharmacy Ordering Terminal can be configured to accept prescription delivery for orders made at other regular computers with internet connections.
The Remote Pharmacy Ordering Terminal can be configured to accept orders for other pharmacies different from the central pharmacy. These orders can be processed on behalf of community pharmacies or forwarded to the central pharmacy for processing.
The Remote Pharmacy Ordering Terminal can be configured to accept refill orders for previously ordered prescriptions on file in the central pharmacy.
The Remote Pharmacy Ordering Terminal can be configured to accept refill orders for previously ordered prescriptions on file in pharmacies different from the central pharmacy.
The Remote Pharmacy Ordering Terminal can be configured to accept transfer of prescriptions filled in other pharmacies to the central pharmacy.
The Remote Pharmacy Ordering Terminal can be configured to accept transfer of prescriptions filled in other pharmacies to pharmacies other than the central pharmacy but facilitated by the central pharmacy.
The Remote Pharmacy Ordering Terminal can be configured to allow transfer of emergency medication to the nearest pharmacy to the customer's location for immediate filling and pickup by the customer.

### Terminology

The term “internet” as used in this disclosure generally refers to a publicly accessible worldwide computer network system adapted to securely receive and transmit information between computers. The various kiosks and processing systems of the invention may be configured to exchange information over the internet, typically in a secure or encrypted form. The components may also be configured to exchange information over a dedicated or shared private network. When the system is configured to collect prescription forms from the consumer, the system need not interact with an electronic prescribing network, although this may be incorporated as an alternative means of receiving information about prescriptions for individual consumers.

The term “electronic kiosk”, “kiosk”, or “remote pharmacy ordering terminal” refers to a computer terminal or device adapted to read and/or receive information about medications and/or other goods needed by a consumer from that consumer or their representative, without direct intervention of an operator, pharmacy professional, or other person. Some electronic kiosks used with this invention are adapted to read information from paper or other forms of hard copy, such as prescription forms, checks, or other information storage media, for example, by way of an optical or electronic scanner. The kiosk then implements various steps needed to provide the service enabled by this invention, and/or transmits information to a central or back-end computer for processing there. When there are multiple kiosks operating in a computer system of this invention, at least one of such kiosks will operate at a location that is remote from the central computer: for example, in a workplace location, in or around a retail pharmacy, or elsewhere in a shopping mall or a location generally available to typical clientele of the system or that particular kiosk.

A “prescription medication” or “prescription pharmaceutical” is a pharmaceutical product that requires a prescription from a physician or other licensed health care worker to be dispensed. “Over the counter” or “OTC” medication is a pharmaceutical product that does not require a prescription, but must be dispensed by a licensed health care worker or pharmacist. The dispensing method, system, and terminals of this invention can be configured to process prescription medication, OTC medication, off-the-shelf medication, medication related products, and other products, in any combination.

The term “prescription form” refers to the original script written on paper or other suitable medium, containing information from a licensed physician regarding prescription medication to be dispensed for a particular consumer in accordance with the needs of that consumer. Unless explicitly permitted, the term “prescription form” does not include a photocopy or other standard reproduction of the original form. Depending on how the invention is implemented, a kiosk inputs information from a prescription form by any technologically suitable means: for example, as described earlier by way of character recognition (OCR). Alternatively or in addition, the kiosk or input means may create an electronic image or duplicate of the prescription form or the information it contains. The inputted information and/or the image file are then typically transmitted to the central computer for processing.

Except where explicitly specified, prescription form can be “collected” from a consumer by any suitable means, such as receiving it into a kiosk of the invention, by obtaining it from the customer in person, by receiving it from the customer by mail.

In a typical implementation of the invention, a prescription pharmaceutical is made available to the consumer only if the original prescription form has been collected from the consumer. A preferred method to accomplish this is by way of the kiosk that scans or takes an image of the prescription form for processing or transmittal to the central computer system. In this implementation, the kiosk collects the prescription form at or around the time of inputting, and keeps it in a secure compartment. It is possible for the secure compartment to be emptied from time to time, with the contents delivered to pharmacies filling the prescriptions, and/or to one or more central processing facilities, where each form may be inspected to determine whether it is a true original or a facsimile thereof, and whether it has been improperly altered. In the event the collected form is a facsimile or contains alterations, the system may decide to cancel the order or take other corrective acts.

Other implementations of the invention may involve, for example, receiving the initial order from the consumer or physician by way of a personal computer or PDA over the internet, and then collecting the prescription form by way of a kiosk; or receiving the initial order over the kiosk, and collecting the prescription form at or around the time the consumer picks up or directly receives the prescription(s) from the prescribing physician by means of fax, phone or electronically before delivery to the consumer of the pharmaceutical product.

Rather than delivering the collected form to the pharmacist or agent doing the dispensing or delivery, the invention can be configured so that the form is authenticated at one location, possibly a central processing facility, and the authorization to dispense the medication is then be transmitted to the dispensing pharmacy or location. The system may comprise a system for tracking, auditing, and storing prescription forms, as required by local regulations.

The system can also be configured to allow the consumer to pre-order the medication before obtaining a prescription from their doctor. In this configuration, the system may transmit this information to the pharmacist in advance, who may prepare and package the product. Once the physician generates the prescription for the consumer, the prescription form is collected by the system, and authorization is given to release or deliver the product to the consumer. In this configuration, a kiosk or an Internet portal acting as a component of the system can optionally be programmed or adapted to prepare a prescription form in advance, naming the medication ordered by the consumer. The doctor can then authorize the medication by signing the form, indicating the dosage and amount of product as required.

A “computer system” of this invention is one or more interconnected electronic processing machines that implement various steps needed to perform an embodiment of the pharmaceutical processing methods provided in this disclosure. Typically, such a system comprises a plurality of kiosks or input terminals at locations that are remote from a central processing, calculating, or decision making unit or units of some kind that are configured or programmed as required to carry out the desired steps. The kiosks may communicate with the central computer by way of the internet or by a dedicated electronic network; either continually or intermittently when needed. The computer system may comprise databases of information about fulfilled and unfulfilled orders, lists of participating pharmacies or outlets, and registries of physicians licensed in the jurisdiction or specialty for which the pharmaceutical is being provided. The information is processed and decisions are made by way of a computer executable code stored on a computer readable medium. Following the ordering and processing steps needed to approve dispensing, the product may be made available to the consumer, for example, for pick-up at a neighboring pharmacy, or it may be delivered to the consumer at their home or business by way of a courier.

The terms “central computer” or “back-end processing system” generally refer to a primary processing unit or units at any location(s) that receives information regarding a consumer's prescription(s), and then implements decision making and the consequences thereof according to the methods of the invention.

The various examples and illustrations referred to in this disclosure are provided for the benefit of the reader, and are not intended to limit the implementation or practice of the invention except where explicitly referred to or otherwise required in the claims that follow. The devices and methods of this invention can be effectively refined or modified by routine optimization without departing from the spirit of the invention embodied in the claims.

The invention claimed is:

1. A computer-implemented method for delivering prescription pharmaceutical products, comprising:
a) inputting order information from a prescription for a particular pharmaceutical product to be dispensed for a particular consumer;
b) verifying that the prescription form is from a licensed physician;
c) verifying the consumer's identity;
and, when all of steps a) through c) are completed,
d) causing said pharmaceutical product to be delivered or otherwise be made available to the consumer, whereby all regulatory requirements for dispensing of said pharmaceutical product are complied with in the jurisdiction where the dispensing takes place.

2. The computer-implemented method of claim 1, wherein step d) is completed only when the original prescription form has been collected from the consumer.

3. The computer-implemented method of claim 1, further comprising determining any possible health issues that would constrain dispensing said pharmaceutical product to the consumer.

4. The computer-implemented method of claim 1, wherein the particular pharmaceutical product is a lotion, a liquid, a product that needs refrigeration, or a controlled substance such as a narcotic.

5. A computer-implemented method for delivering prescription pharmaceutical products, comprising:
a) receiving a request to dispense a particular pharmaceutical product for a particular consumer;
b) verifying that the prescription is from a licensed physician;
c) verifying the consumer's identity;
d) collecting at an electronic kiosk a prescription form that prescribes dispensing said pharmaceutical product for said consumer;
and, when all of steps a) through d) are completed,
e) causing said pharmaceutical product to be delivered or otherwise be made available to the consumer, whereby all regulatory requirements for dispensing of said pharmaceutical product are complied with in the jurisdiction where the dispensing takes place.

6. A computer system adapted to perform the method of claim 1, thereby causing said pharmaceutical product to be delivered or otherwise be made available to a consumer in accordance with a prescription form presented by that consumer.

7. The computer system of claim 6, programmed to cause said pharmaceutical product to be delivered or otherwise made available to the consumer only after said prescription form has been collected from the consumer or from a health care professional who has written the prescription.

8. The computer system of claim 6, further comprising a plurality of dedicated electronic kiosks adapted to read information from a prescription form.

9. The computer system of claim 8, wherein at least some of said electronic kiosks are adapted to collect and secure said prescription form.

10. The computer system of claim 8, wherein at least some of said electronic kiosks are adapted to receive payment information from a check, or by an electronic payment means, such as an insurance health card, a credit card, or a debit card.

11. The computer system of claim 6, further comprising an internet portal by which a consumer may ascertain status of an order for prescription mediation, and/or request a refill or prescription transfer.

12. A computer system adapted to perform the method of claim 5, thereby causing said pharmaceutical product to be delivered or otherwise be made available to a consumer in accordance with a prescription form presented by that consumer.

13. A remote pharmacy ordering terminal for ordering one or more prescription pharmaceutical products according to the method of claim 1, the terminal comprising:
a) an input means for obtaining prescribing information from a prescription form written for a particular pharmaceutical product to be dispensed for a particular consumer, wherein such prescribing information comprises the name of the consumer, the identity of the pharmaceutical product(s) to be dispensed, the prescribed dosage, and the frequency the product is to be taken by the consumer;
b) an input means for obtaining information that identifies the consumer;
c) a transmittal means for sending such prescribing information to a back-end processing system adapted to cause said pharmaceutical product to be delivered or otherwise made available to the consumer in compliance with regulatory requirements according to the method; and
d) a computer processing unit for determining when such prescribing information and identifying information has been inputted by the terminal, thereafter causing such information to be sent to the back-end processing system.

14. The remote pharmacy ordering terminal of claim 13, wherein the input means is an optical character recognition system or imaging device adapted to obtain such information from prescription forms.

15. The remote pharmacy ordering terminal of claim 13, further comprising a compartment for receiving and securing prescription forms once each form has been collected from a consumer ordering a pharmaceutical product by way of the terminal.

16. A method for providing medication to a particular consumer having a prescription for said medication, the method comprising:
a) receiving information from a computer system according to claim 6 regarding a particular pharmaceutical product to be dispensed to the consumer; and
b) delivering the pharmaceutical product to the consumer once the computer system has verified the consumer's identity and that the prescription is from a licensed physician.

17. A computer-implemented method for delivering non-prescription products in conjunction with, prescription pharmaceutical products, the method comprising:
a) inputting order information for a non-prescription product;
b) inputting order information for a prescription pharmaceutical product according to the method of claim 1;
c) verifying the consumer's identity;
d) collecting payment;
and, when all of steps a) through d) are completed,
e) causing said non-prescription and prescription products to be delivered or otherwise be made available to the consumer either together or separately.

18. A computer system adapted to perform the method of claim 17, thereby causing said products to be delivered or otherwise be made available to a consumer.
